(19) United States
(12) Patent Application Publication
(10) Pub. No.: US 2011/0157864 A1
(43) Pub. Date: Jun. 30, 2011

(54) LIGHT EMITTING DEVICE

(75) Inventors: Yasushi HATTORI, Kanagawa (JP); Masaki Tohyama, Kanagawa (JP); Shinji Saito, Kanagawa (JP); Shinya Nunoue, Chiba (JP); Maki Sugai, Tokyo (JP); Rei Hashimoto, Tokyo (JP)

(73) Assignee: Kabushiki Kaisha Toshiba, Tokyo (JP)

(21) Appl. No.: 12/876,774

(22) Filed: Sep. 7, 2010

(30) Foreign Application Priority Data
Dec. 28, 2009 (JP) 2009-297069

(51) Int. Cl. F21V 9/16

(52) U.S. Cl. 362/84

(57) ABSTRACT

According to embodiments, a light emitting device is provided. The light emitting device includes a semiconductor laser diode that emits a laser beam; first and second sidewalls that are disposed along a central beam axis of the laser beam with opposite each other; a phosphor layer that is provided between the first and second sidewalls, the phosphor layer including an incidence surface of the laser beam, the incidence surface being provided while inclined with respect to the central beam axis, the phosphor layer absorbing the laser beam to emit visible light on the incidence surface side; a slit that is provided on the incidence surface side of the phosphor layer to take out the visible light, the slit including a longitudinal direction and a crosswise direction, the longitudinal direction being disposed along a direction of the central beam axis; and a reflector that is provided on the slit side of the semiconductor laser diode so as not to intersect the central beam axis, the reflector reflecting part of the laser beam toward the phosphor layer.

This application is based upon and claims the benefit of priority from Japanese Patent Application No. 2009-297069, filed on Dec. 28, 2009, the entire contents of which are incorporated herein by reference.

### FIELD

Embodiments described herein relate generally to a light emitting device in which a semiconductor laser diode is used as a light source.

### BACKGROUND

There have been proposed various light emitting devices in which a semiconductor light emitting element and a phosphor are combined. In such light emitting devices, the phosphor absorbs excitation light from the semiconductor light emitting element and emits light whose wavelength is different from that of the excitation light.

For example, there has been proposed a light emitting device, in which a laser beam emitted from the semiconductor laser diode is reflected by a reflective plate and struck on a phosphor layer containing the phosphor. For example, there has been proposed a light emitting device, in which a laser beam emitted from the semiconductor laser diode is reflected by a reflective plate having a curved surface and struck on the phosphor layer.

However, the proposed technique is not enough to efficiently obtain linear visible light used in, for example, a backlight of a liquid crystal display.

### BRIEF DESCRIPTION OF THE DRAWINGS

FIG. 1 is a schematic perspective view illustrating a light emitting device according to a first embodiment of the invention;

FIG. 2 is a schematic sectional view illustrating the light emitting device of the first embodiment when viewed from an A direction of FIG. 1;

FIG. 3 is a sectional view illustrating a first example of a semiconductor laser diode;

FIG. 4 is a sectional view illustrating a second example of the semiconductor laser diode;

FIG. 5 is a sectional view illustrating a third example of the semiconductor laser diode;

FIG. 6 is an explanatory view illustrating an intensity distribution of a laser beam emitted from the semiconductor laser diode;

FIG. 7 is a view explaining an action and an effect of the light emitting device of the first embodiment;

FIG. 8 is a schematic sectional view illustrating a light emitting device according to a second embodiment of the invention;

FIG. 9 is a view illustrating an effect of the light emitting device of the second embodiment;

FIG. 10 is a schematic sectional view illustrating a light emitting device according to a third embodiment of the invention;

FIG. 11 is a schematic sectional view illustrating a light emitting device according to a fourth embodiment of the invention; and

FIG. 12 is a schematic sectional view illustrating a light emitting device according to a fifth embodiment of the invention.

### DETAILED DESCRIPTION

According to one embodiment, a light emitting device is provided. The light emitting device includes a semiconductor laser diode that emits a laser beam; first and second sidewalls that are disposed along a central beam axis of the laser beam with opposite each other; a phosphor layer that is provided between the first and second sidewalls, the phosphor layer including an incidence surface of the laser beam, the incidence surface being provided while inclined with respect to the central beam axis, the phosphor layer absorbing the laser beam to emit visible light on the incidence surface side; a slit that is provided on the incidence surface side of the phosphor layer to take out the visible light, the slit including a longitudinal direction and a crosswise direction, the longitudinal direction being disposed along a direction of the central beam axis; and a reflector that is provided in a region between the semiconductor laser diode and the slit so as not to intersect the central beam axis, the reflector reflecting part of the laser beam toward the phosphor layer. Embodiments of the invention will be described below with reference to the drawings. In the drawings, the identical or similar part is designated by the identical or similar numeral. For the sake of convenience, hereinafter “upper surface” and “upper side” of the light emitting device means a direction in which the visible light is taken out, “lower surface” and “lower side” means the opposite direction.

### First Embodiment

A light emitting device according to a first embodiment of the invention includes: a semiconductor laser diode that emits a laser beam; first and second sidewalls that are disposed along a central beam axis of the laser beam with opposite each other; a phosphor layer that is provided between the first and second sidewalls, the phosphor layer including an incidence surface of the laser beam, the incidence surface being provided while inclined with respect to the central beam axis, the phosphor layer absorbing the laser beam to emit visible light on the incidence surface side; a slit that is provided on the incidence surface side of the phosphor layer to take out the visible light, the slit including a longitudinal direction and a crosswise direction, the longitudinal direction being disposed along a direction of the central beam axis; and a reflector that is provided in a region between the semiconductor laser diode and the slit so as not to intersect the central beam axis, the reflector reflecting part of the laser beam toward the phosphor layer. For example, the light emitting device is used in the backlight of the liquid crystal display.

In the light emitting device of the first embodiment, the provision of the phosphor layer can shorten a distance between the phosphor layer and the slit that takes out the visible light. Accordingly, light intensity loss that is generated in a pathway in which the visible light reaches the slit from the phosphor layer can be suppressed to implement the high-efficiency light emitting device.

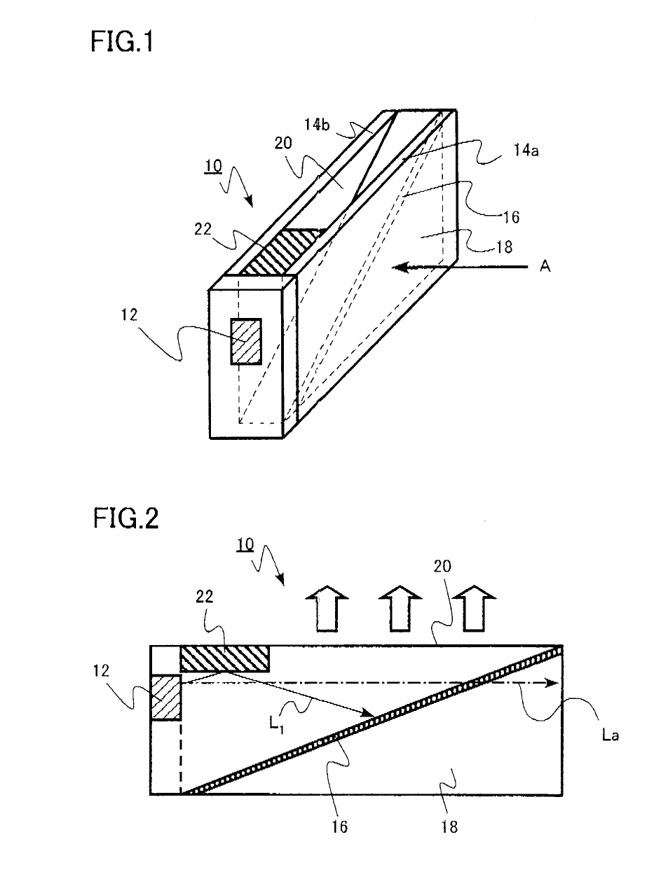

FIG. 1 is a schematic perspective view illustrating a light emitting device according to the first embodiment of the invention. FIG. 2 is a schematic sectional view illustrating the light emitting device of the first embodiment when viewed from an A direction of FIG. 1.

A light emitting device 10 includes a semiconductor laser diode 12 that emits the laser beam, and includes a first sidewall 14a and a second sidewall 14b. The first sidewall 14a and the second sidewall 14b are disposed in substantially parallel along a central beam axis La of the laser beam, and are substantially provided opposite each other.

A phosphor layer 16 is provided between the first sidewall 14a and the second sidewall 14b while inclined with respect to the central beam axis La. The phosphor layer 16 is formed on a seat 18. A surface on the upper side of the phosphor layer 16 constitutes the incidence surface of the laser beam. The incidence surface is inclined with respect to the central beam axis La of the laser beam. The incidence surface may also be called an incidence surface. The phosphor layer 16 absorbs the laser beam to emit the visible light indicated by a white arrow in FIG. 2 on the incidence surface side. Hereinafter occasionally the incidence surface is simply referred to as an inclined surface.

The light emitting device 10 also includes a slit 20 that takes out the visible light in an upper portion thereof. The slit has a longitudinal direction and a crosswise direction, and the longitudinal direction is disposed along the direction of the central beam axis La. A reflector 22 is provided on the side of the slit 20 of the semiconductor laser diode 12, that is, on the upper side of the semiconductor laser diode 12 in FIG. 2.

The reflector 22 is disposed in an end on the side of the semiconductor laser diode 12 of the slit 20 so as not to intersect the central beam axis La. In the first embodiment, the reflector 22 is disposed such that a lower surface of the reflector 22 is substantially parallel to the central beam axis La. On the side of the slit 20 of the semiconductor laser diode 12, that is, on the upper side of the semiconductor laser diode 12 in FIG. 2, the reflector 22 reflects part (L₁ in FIG. 2) of the emitted laser beam toward the phosphor layer 16.

Desirably a semiconductor laser diode having an emission peak wavelength in a blue to ultraviolet wavelength region of 430 nm or less is used as the semiconductor laser diode 12. For example, an AlGaInN laser diode can be used.

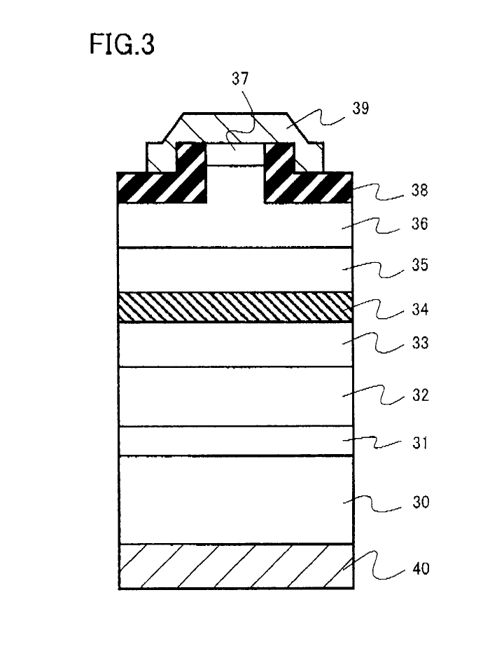

FIG. 3 is a sectional view illustrating a first example of the semiconductor laser diode. The semiconductor laser diode is an edge emitting AlGaInN laser diode in which GaInN that is a III-V compound semiconductor is used as a light emission layer.

The semiconductor laser diode has a structure in which an n-type GaN buffer layer 31, an n-type AlGaN cladding layer 32, an n-type GaN optical guide layer 33, a GaInN light emission layer 34, a p-type GaN optical guide layer 35, a p-type AlGaN cladding layer 36, and a p-type GaN contact layer 37 are sequentially stacked on an n-type GaN substrate 30. Insulating films 38 are provided on a ridge face of the p-type GaN contact layer 37 and a surface of the p-type AlGaN cladding layer 36. A p-side electrode 39 is provided on surfaces of the p-type GaN contact layer 37 and the insulating film 38, and an n-side electrode 40 is provided on a rear surface of the n-type GaN substrate 30. The laser beam is emitted from the GaInN light emission layer 34 by applying an operating voltage between the p-side electrode 39 and the n-side electrode 40.

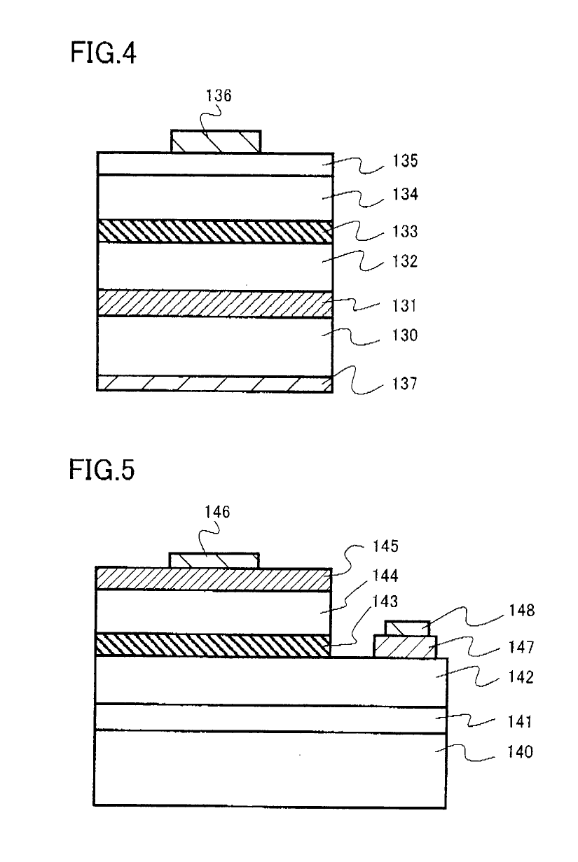

FIG. 4 is a sectional view illustrating a second example of the semiconductor laser diode. The semiconductor laser diode is an edge emitting MgZnO laser diode in which MgZnO that is a II-VI compound semiconductor is used as the light emission layer.

The semiconductor laser diode has a structure in which a metallic reflecting layer 131, a p-type MgZnO cladding layer 132, an i-type MgZnO light emission layer 133, an n-type MgZnO cladding layer 134, and an n-type MgZnO contact layer 135 are sequentially stacked on a zinc oxide (ZnO) substrate 130. An n-side electrode 136 is provided in the n-type contact layer 135. A p-side electrode 137 is provided on the substrate 130.

FIG. 5 is a sectional view illustrating a third example of the semiconductor laser diode. The semiconductor laser diode is also the edge emitting MgZnO laser diode in which MgZnO that is the II-VI compound semiconductor is used as the light emission layer.

The semiconductor laser diode has a structure in which a ZnO buffer layer 141, a p-type MgZnO cladding layer 142, a MgZnO light emission layer 143, and an n-type MgZnO cladding layer 144 are sequentially stacked on a Si substrate 140. An n-side electrode 146 is provided on the n-type cladding layer 144 with an Indium Tin Oxide (ITO) electrode layer 145 interposed therebetween. A p-side electrode 148 is provided on the p-type cladding layer 142 with an ITO electrode layer 147 interposed therebetween.

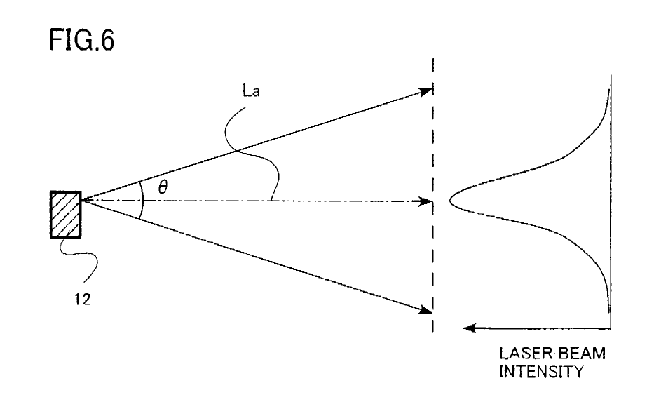

FIG. 6 is an explanatory view illustrating an intensity distribution of the laser beam emitted from the semiconductor laser diode. As illustrated in FIG. 6, for example, the laser beam emitted from the end face of the semiconductor laser diode 12 has a vertical spread angle θ of 60 degrees around the central beam axis La that is the maximum intensity direction of the laser beam. An intensity distribution of the laser beam exhibits a Gaussian distribution in which the intensity on the central beam axis becomes an average value as illustrated in FIG. 6.

The phosphor layer 16 has a structure in which phosphor particles are dispersed in a transparent base material. The laser beam that is struck on the phosphor layer 16 to become excitation light is absorbed by the phosphor particles and converted into the visible light having a wavelength different from that of the excitation light. A content of the phosphor particle in the phosphor layer 16 is adjusted such that the laser beam is efficiently converted into the visible light.

An inclination angle of the surface of the phosphor layer 16 with respect to the central beam axis of the laser beam is determined in consideration of a length in the longitudinal direction of an emission shape of the light emitting device and emission intensity of the visible light.

For example, (Sr,Ca,Ba)₁₀(PO₄)₆Cl₂:Eu that is the blue phosphor and 3(Sr,Ca,Ba)₂Si₂O₄:Eu that is the yellow phosphor are used as the phosphor particles. For example, a silicone resin is used as the transparent base material. The two kinds of the phosphor particles are mixed together and dispersed in the silicone resins to form the phosphor layer 16.

Desirably the phosphor particle has a particle diameter ranging from 5 to 25 μm. Particularly particles having large diameters of about 20 μm or more are desirably used as the phosphor particle because of high emission intensity and high luminous efficiency. When the particle diameter of the phosphor particle is lower than 5 μm, the phosphor particle is not suitable to the fluorescent body because of the low absorption factor of the fluorescent body and the easy degradation of the fluorescent body. When the particle diameter of the phosphor particle exceeds 25 μm, the phosphor layer 16 is hardly formed, and color unevenness is easily generated.

In the first embodiment, for example, the phosphor layer 16 is made of aluminum and formed on the seat 18 having a slope shape. Desirably the phosphor layer 16 is formed on the seat 18 because the phosphor layer 16 is easily molded. However, it is not always necessary that the phosphor layer 16 be formed on the seat.

For example, the first sidewall 14a and the second sidewall 14b are formed by flat plates made of aluminum. A width of the visible light is controlled by providing the first sidewall 14a and the second sidewall 14b, whereby the emission shape of the light emitting device becomes linear.

In the first sidewall 14a and the second sidewall 14b, desirably the inner surface side is mirror-polished such that reflectances of the laser beam and visible light increase. The increased reflectances of the laser beam and visible light can implement the light emitting device having the good efficiency.

The slit 20 is provided on the incidence surface side of the phosphor layer 16, that is, above the phosphor layer 16. The longitudinal direction of the slit 20 is substantially matched with the direction of the central beam axis La of the laser beam. A length in the longitudinal direction is defined by an end of the reflector 22 and an end on the side of the phosphor layer 16 located farther than the semiconductor laser diode 12. A width in the crosswise direction of the slit 20 is defined by a gap between the first sidewall 14a and the second sidewall 14b.

The visible light emitted from the phosphor layer 16 is directly reflected, or the visible light is reflected by inner surfaces of the first sidewall 14a and second sidewall 14b, thereby taking out the visible light from the slit 20 to the outside of the light emitting device 10. The emission shape of the light emitting device 10 becomes linear according to the shape of the slit 20.

For example, the reflector 22 is formed by a flat plate made of aluminum. The reflector 22 partially reflects the laser beam, which strays onto the upper side of the semiconductor laser diode 12 from the central beam axis La in the emitted laser beams, toward the phosphor layer 16 (see FIG. 2). Desirably the lower surface side of the reflector 22 is mirror-polished such that the reflectance of the laser beam increases. The increased reflectance of the laser beam can implement the light emitting device having the good efficiency.

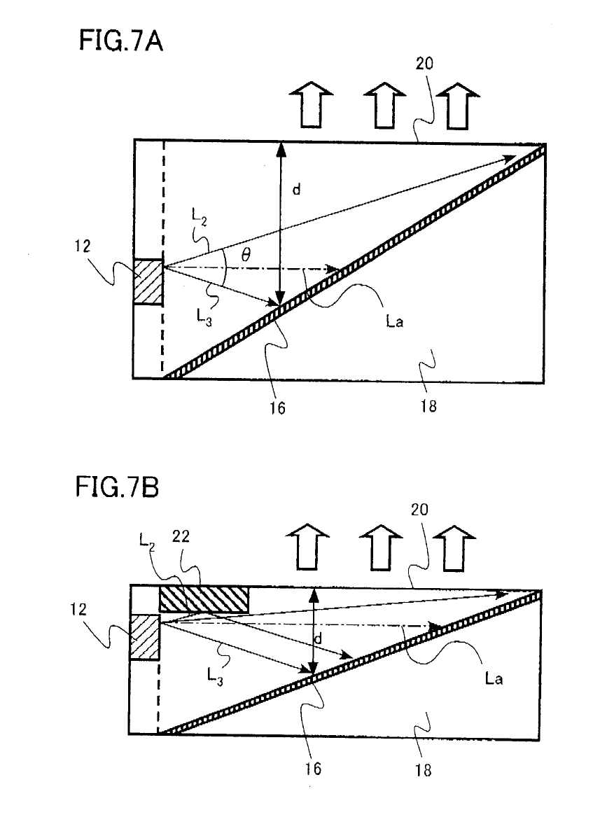

FIG. 7 is a view explaining an action and an effect of the light emitting device of the first embodiment. FIG. 7A illustrates a light emitting device in which the reflective plate is not provided, FIG. 7B illustrates the light emitting device of the first embodiment in which the reflective plate is provided.

Generally, because of concern about an adverse effect on a human body, the light emitting device is designed such that the laser beam that becomes the excitation light is not emitted out of the light emitting device. Therefore, as illustrated in FIG. 7A, when the laser beam vertically having a spread angle, it is necessary that the end of the phosphor layer 16 farther away from the semiconductor laser diode 12 be positioned above an top (L₂ in FIG. 7) of the laser beam distribution.

At this point, particularly a distance (two-headed arrow d in FIG. 7) between the position of the phosphor layer 16 irradiated with the laser beam near a bottom (L₃ in FIG. 7) in the laser beam distribution and the slit 20 in which the visible light is taken out is lengthened. In other words, a depth of the phosphor layer 16 on the side closer to the semiconductor laser diode 12 increases when viewed from the slit 20. This causes a problem of the increased light intensity loss generated in reflecting the visible light from the sidewall (not illustrated).

In the light emitting device illustrated in FIG. 7B, the reflective plate 22 is provided on the side of the slit 20 near the semiconductor laser diode 12, that is, above the neighborhood of the semiconductor laser diode 12. In such cases, the laser beam near the top (L₂ in FIG. 7) of the laser beam distribution is reflected toward the phosphor layer 16 by the reflective plate 22.

Accordingly, while the laser beam does not stray to the outside of the light emitting device 10, the distance (two-headed arrow d in FIG. 7) between the position of the phosphor layer 16 and the slit 20 in which the visible light is taken out can be shortened compared with the case where the reflector 22 is eliminated. In other words, the depth of the phosphor layer 16 on the side closer to the semiconductor laser diode 12 can decrease when viewed from the slit 20. Therefore, the light intensity loss generated in reflecting the visible light from the sidewall (not illustrated) can be reduced compared with the case where the reflector 22 is eliminated.

The depth of the phosphor layer 16 on the side closer to the semiconductor laser diode 12 decreases when viewed from the slit 20, which allows the low-profile light emitting device to be implemented. Therefore, the miniaturization of the light emitting device is also realized. When the reflector 22 is eliminated, because the depth of the phosphor layer 16 on the side closer to the semiconductor laser diode 12 increases when viewed from the slit 20, the light intensity of the visible light taken out from the portion in which the depth increases becomes lower than that of other portions to degrade the light intensity distribution in the longitudinal direction of the slit. In the first embodiment, the light intensity distribution in the longitudinal direction of the slit is also improved because the light intensity loss is reduced in the portion in which the depth increases.

### Second Embodiment

In the first embodiment, the inclination angle of the laser beam, which is the phosphor layer surface, with respect to the central beam axis of the laser beam is kept constant. On the other hand, the inclination angle is not kept constant in a light emitting device according to a second embodiment of the invention. The incidence surface has a region, where the inclination angle is larger than that at a position at which the incidence surface intersects the central beam axis, at a position that is farther from the semiconductor laser diode than the position at which the incidence surface intersects the central beam axis.

In the light emitting device of the second embodiment, the inclination angle of the phosphor layer surface at the position farther from the semiconductor laser diode increases, whereby the light intensity of the visible light taken out from the portion in which the inclination angle increases can be increased. Therefore, the light intensity distribution in the longitudinal direction of the slit can further be improved.

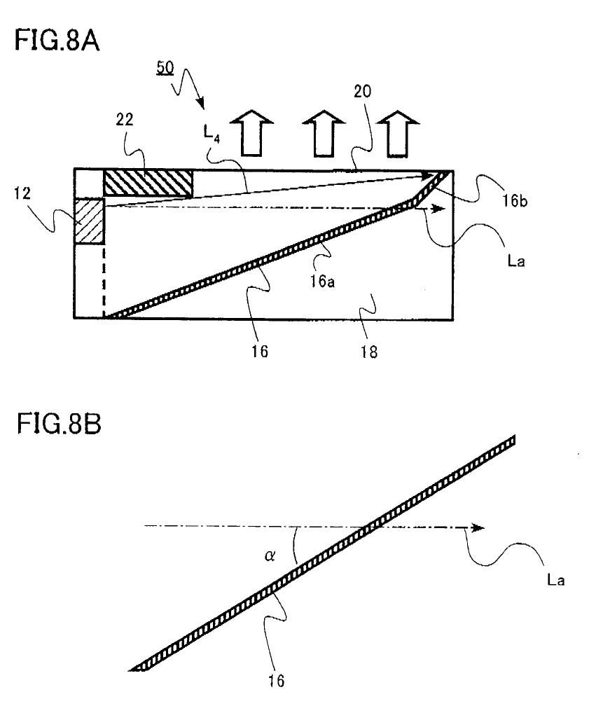

FIG. 8 is a schematic sectional view illustrating a light emitting device according to a second embodiment of the invention. FIG. 8A is a schematic sectional view of the light emitting device, and FIG. 8B is an explanatory view of a definition of an inclination angle. The inclination angle with respect to the central beam axis of the incidence surface that is the upper-side surface of the phosphor layer 16 means an angle formed by the incidence surface and the central beam axis direction, that is, an angle α of FIG. 8B. As illustrated in FIG. 8A, the phosphor layer 16 of a light emitting device 50 includes a region 16a having the small inclination angle of the incidence surface with respect to the central beam axis La of the laser beam and a region 16b having the large inclination angle.

The region 16b is located farther away from the semiconductor laser diode 12 than the region 16a. Therefore, the region 16b having the large inclination angle is irradiated with part L₄ of the laser beam that is emitted above the central beam axis La from the semiconductor laser diode 12.

The intensity of the laser beam emitted from the semiconductor laser diode 12 has a Gaussian distribution as illustrated in FIG. 6. Therefore, the intensity of the laser beam L₄ emitted above the central beam axis La is weaker than that of the laser beam close to the central beam axis La. Because the surface of the phosphor layer 16 is inclined with respect to the central beam axis La, the light intensity of the laser beam with which a unit area in the surface of the phosphor layer 16 is irradiated tends to decrease with distance from the semiconductor laser diode 12. As a result, the intensity of the visible light taken out from the slit 20 decreases with distance from the semiconductor laser diode 12, and the light intensity distribution in the longitudinal direction of the slit is degraded.

In the light emitting device 50, the light intensity of the laser beam with which the unit area in the surface of the phosphor layer 16 is irradiated increases by increasing the inclination angle of the region 16b, thereby increasing the light intensity of the visible light per unit area in the region 16b. Additionally the apparent visible light intensity also increases when viewed from the side of the slit 20. Accordingly, the emission intensity of the visible light increases in the region 16b to be able to further improve the light intensity distribution in the longitudinal direction of the slit.

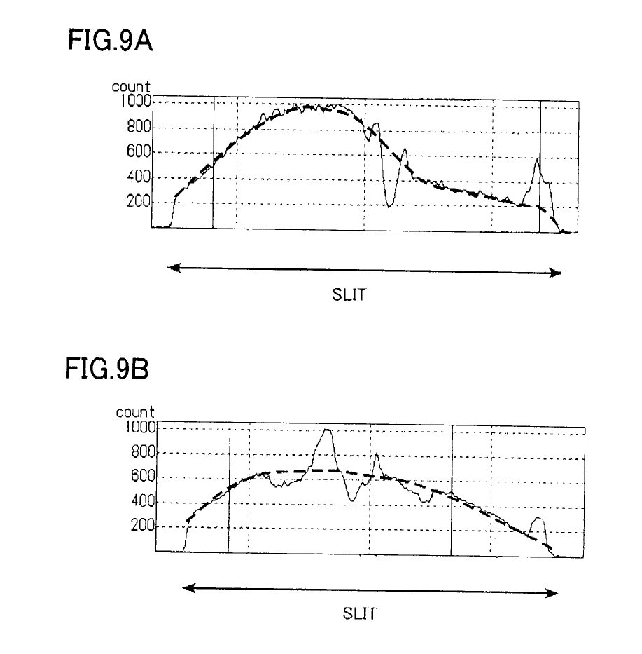

FIG. 9 is a view illustrating an effect of the light emitting device of the second embodiment. FIG. 9A illustrates the case where the inclination of the phosphor layer surface is kept constant like the first embodiment, and FIG. 9B illustrates the second embodiment. A horizontal axis indicates a position in the longitudinal direction of the slit, and the left of FIG. 9 is the semiconductor laser diode side. A vertical axis indicates a measured value of the intensity of the visible light taken out from the slit, and the measured value is expressed by an arbitrary unit in which the maximum intensity is set to 1000. The measured value is indicated by a solid line, and result of fitting is indicated by a dotted line. A variation in the measured value is attributed to the fact that, for example, the phosphor layer is unevenly formed due to uneven application.

In FIG. 9A, the visible light intensity is weakened to degrade the evenness of the visible light intensity at the position farther away from the semiconductor laser diode side. On the other hand, in FIG. 92, the visible light intensity is strengthened to improve the evenness of the visible light intensity at the position farther away from the semiconductor laser diode side.

As described above, the laser beam intensity is maximized in the central beam axis portion. Accordingly, from the viewpoint of improving the evenness of the intensity of the taken-out visible light, like the second embodiment, desirably the inclination angle of the incidence surface that is the upper-side surface of the phosphor layer with respect to the central beam axis of the laser beam is minimized at the position at which the incidence surface intersects the central beam axis.

### Third Embodiment

In the first embodiment, the inclination angle of the laser beam, which is the phosphor layer surface, with respect to the central beam axis of the laser beam is kept constant. On the other hand, the inclination angle is not kept constant in a light emitting device according to a third embodiment of the invention. Unlike the second embodiment, the incidence surface has a region, where the inclination angle is larger than that at a position at which the incidence surface intersects the central beam axis, at a position that is closer to the semiconductor laser diode than the position at which the incidence surface intersects the central beam axis.

In the light emitting device of the third embodiment, the inclination angle of the phosphor layer surface increases at the position close to the semiconductor laser diode, whereby the light intensity of the visible light taken out from the portion in which the inclination angle increases can be increased. Therefore, the light intensity distribution in the longitudinal direction of the slit can further be improved.

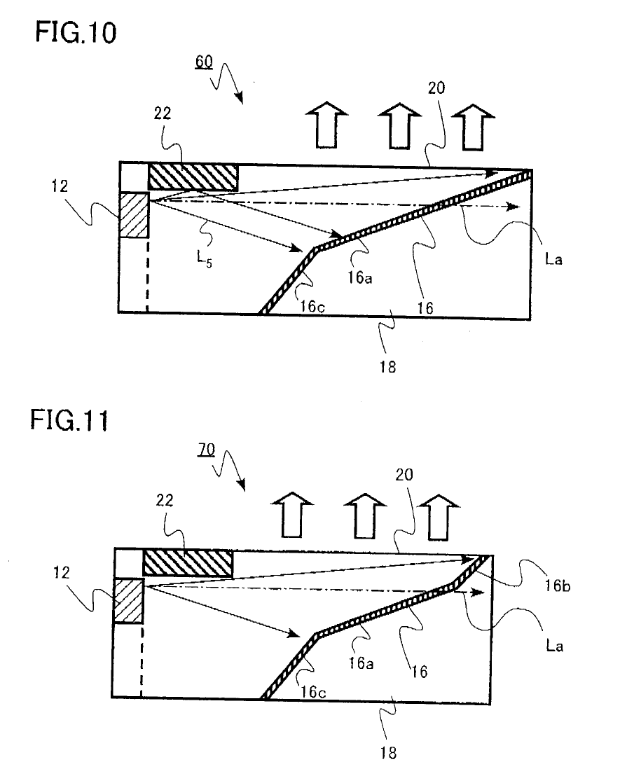

FIG. 10 is a schematic sectional view illustrating a light emitting device according to the third embodiment of the invention. As illustrated in FIG. 10, the phosphor layer 16 of the light emitting device 60 includes the region 16a having the small inclination angle of the incidence surface that is the upper-side surface of the phosphor layer 16 with respect to the central beam axis La of the laser beam and a region 16c having the large inclination angle.

The region 16c is located closer to the semiconductor laser diode 12 than the region 16a. Therefore, the region 16c having the large inclination angle is irradiated with part L₅ of the laser beam that is emitted below the central beam axis La from the semiconductor laser diode 12.

The intensity of the laser beam emitted from the semiconductor laser diode 12 has a Gaussian distribution as illustrated in FIG. 6. Therefore, the intensity of the laser beam L₅ emitted below the central beam axis La is weaker than that of the laser beam close to the central beam axis La. Although a distance between the phosphor layer 16 and the slit through which the visible light is taken out is shortened by providing the reflector 22, the distance in the region 16c becomes longer than that in other regions. Accordingly, the light intensity loss generated in the pathway through which the visible light reaches the slit 20 from the phosphor layer 16 becomes larger than that in other regions. As a result, the intensity of the visible light taken out from the slit 20 decreases toward the semiconductor laser diode 12, and the light intensity distribution in the longitudinal direction of the slit is degraded.

In the light emitting device 60, the light intensity of the laser beam with which the unit area in the surface of the phosphor layer 16 is irradiated increases by increasing the inclination angle of the region 16c, thereby increasing the light intensity of the visible light per unit area in the region 16c. Additionally the apparent visible light intensity also increases when viewed from the side of the slit 20. Accordingly, the emission intensity of the visible light increases in the region 16c to be able to further improve the light intensity distribution in the longitudinal direction of the slit.

In the third embodiment, similarly to the second embodiment, desirably the inclination angle of the incidence surface that is the upper-side surface of the phosphor layer with respect to the central beam axis of the laser beam is minimized at the position at which the incidence surface intersects the central beam axis.

### Fourth Embodiment

In the first embodiment, the inclination angle of the laser beam, which is the phosphor layer surface, with respect to the central beam axis of the laser beam is kept constant. On the other hand, the inclination angle is not kept constant in a light emitting device according to a fourth embodiment of the invention. The incidence surface has a region, where the inclination angle is larger than that at a position at which the incidence surface intersects the central beam axis, at a position that is farther from the semiconductor laser diode than the position at which the incidence surface intersects the central beam axis and at a position that is closer to the semiconductor laser diode than the position at which the incidence surface intersects the axis. That is, the fourth embodiment is a mode in which the second embodiment and the third embodiment are combined.

FIG. 11 is a schematic sectional view illustrating a light emitting device according to a fourth embodiment of the invention. As illustrated in FIG. 11, the phosphor layer 16 of a light emitting device 70 includes the region 16a having the small inclination angle of surface of the phosphor layer 16 with respect to the central beam axis La of the laser beam and the regions 16b and 16c having the large inclination angles.

In the light emitting device of the fourth embodiment, the inclination angles of the phosphor layer surfaces at the position farther away from the semiconductor laser diode and the position closer to the semiconductor laser diode increase, whereby the light intensity of the visible light taken out from each of the portions in which the inclination angles increases can be increased. Therefore, the light intensity distribution in the longitudinal direction of the slit can further be improved.

In the fourth embodiment, similarly to the second and third embodiments, desirably the inclination angle of the incidence surface that is the upper-side surface of the phosphor layer with respect to the central beam axis of the laser beam is minimized at the position at which the incidence surface intersects the central beam axis.

### Fifth Embodiment

The incidence surface is formed by a continuous curved surface in a light emitting device according to a fifth embodiment of the invention, while the incidence surface that is the phosphor layer surface is formed by the flat surface in the fourth embodiment.

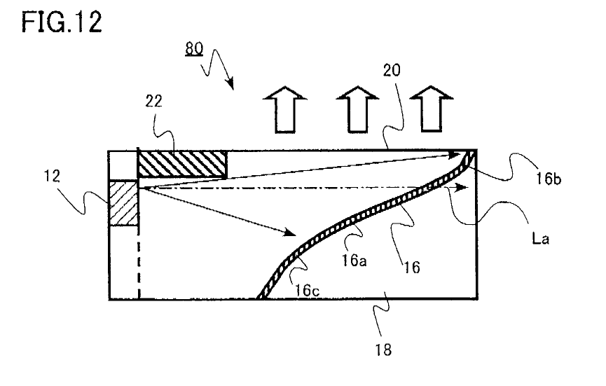

FIG. 12 is a schematic sectional view illustrating a light emitting device according to a fifth embodiment of the invention. As illustrated in FIG. 12, the phosphor layer 16 of a light emitting device 80 includes the region 16a having the small inclination angle of the incidence surface that is the upper-side surface of the phosphor layer 16 with respect to the central beam axis La of the laser beam and regions 16b and 16c having the large inclination angle. The surface of the phosphor layer 16 is formed by the continuous curved surface. That is, the phosphor layer 16 is formed on the seat 18, and the surface of the phosphor layer 16 is formed by the curved surface that is projected upward from the side of the semiconductor laser diode 12 and the curved surface that is projected downward while leading to the curved surface projected upward.

When the surface of the phosphor layer 16 or the incidence surface is formed by the curved surface, the inclination angle with respect to the central beam axis La of the laser beam shall mean an angle formed by a plane that is in contact with the curved surface and the central beam axis La of the laser beam.

In the light emitting device of the fifth embodiment, because the surface of the phosphor layer 16 is formed by the continuous curved surface, the intensity of the visible light taken out from each position in the surface of the phosphor layer 16 is continuously corrected. Accordingly, the light intensity distribution in the longitudinal direction of the slit can be improved further than the light emitting device of the fourth embodiment.

In the fifth embodiment, similarly to the second to fourth embodiments, desirably the inclination angle of the laser beam incidence surface that is the phosphor layer surface with respect to the central beam axis of the laser beam is minimized at the position at which the incidence surface intersects the central beam axis.

While certain embodiments have been described, these embodiments have been presented by way of example only, and are not intended to limit the scope of the inventions. Indeed, the light emitting device described herein may be embodied in a variety of other forms; further more, various omissions, substitutions and changes in the form of the devices and methods described herein may be made without departing from the spirit of the inventions. The accompanying claims and their equivalents are intended to cover such forms or modifications as would fall within the scope and spirit of the inventions.

The AlGaInN laser diode in which the light emission layer is made of GaInN is used in the embodiments. A semiconductor laser diode using aluminum nitride/gallium nitride/iridium nitride (AlGaInN) that is a III-V compound semiconductor or magnesium oxide/zinc oxide (MgZnO) that is a II-VI compound semiconductor can be used as the light emission layer (active layer). For example, the III-V compound semiconductor used as the light emission layer is a nitride semiconductor that contains at least one element selected from a group consisting of Al, Ga, and In. Specifically, the nitride semiconductor is expressed by AlₓGa_{y}In_{(1-x-y)}N (0≦x≦1, 0≦y≦1, 0≦(x+y)≦1). The nitride semiconductor includes binary semiconductors such as AlN, GaN, and InN, ternary semiconductors such as AlₓGa₍₁₋ₓ₎N (0≦x≦1), AlₓIn₍₁₋ₓ₎N (0≦x≦1), and Ga_{y}In_{(1-y)}N (0≦y≦1), and quaternary semiconductors including all the elements. The emission peak wavelength is determined in the range of ultraviolet to blue based on compositions x, y, and (1-x-y) of Al, Ga, and In. Part of the III-group element can be substituted for boron (B), thallium (Tl), and the like. Part of N that is the V-group element can be substituted for phosphorous (P), arsenic (As), antimony (Sb), bismuth (Bi) and the like.

Similarly, an oxide semiconductor containing at least one of Mg and Zn can be used as the II-VI compound semiconductor that is used as the light emission layer. Specifically, the oxide semiconductor expressed by Mg_{z}Zn_{(1-z)}O (0≦z≦1) is used as the II-VI compound semiconductor, and the emission peak wavelength in the ultraviolet region is determined based on compositions z and (1-z) of Mg and Zn.

The silicone resin is used as the transparent base material of the phosphor layer in the embodiments. Alternatively, any material having the high permeability of the excitation light and a high heat-resistant property may be used as the transparent base material. In addition to silicone resin, examples of the material include an epoxy resin, a urea resin, a fluorine resin, an acrylic resin, and a polyimide resin. Particularly the epoxy resin or the silicone resin is suitably used because of easy availability, easy handling, and low cost. A ceramic structure in which glass, a sintered body, or Yttrium Aluminum Garnet (YAG) and alumina (Al₂O₃) are combined may be used in addition to the resins.

The phosphor particle is made of a material that absorbs the light having the wavelength region of ultraviolet to blue to emit the visible light. For example, phosphors such as a silicate phosphor, an aluminate phosphor, a nitride phosphor, a sulfide phosphor, an oxysulfide phosphor, a YAG phosphor, a borate phosphor, a phosphate-borate phosphor, a phosphate phosphor, and a halophosphate phosphor can be used. The compositions of the phosphors are shown below.

(1) Silicate phosphor: (Sr_{(1-x-y-z)}BaₓCa_{y}Eu_{z})₂Si_{w}O_{(2+2w)} (0≦x≦1, 0≦y≦1, 0.05≦z≦0.2, and 0.90≦w≦1.10)

The compositions of x=0.19, y=0, z=0.05, and w=1.0 is desirable in the silicate phosphor expressed by the chemical formula. In order to stabilize the crystal structure or enhance the emission intensity, part of strontium (Sr), barium (Ba), and calcium (Ca) may be substituted for at least one of Mg and Zn. For example, MSiO₃, MSiO₄, M₂SiO₃, M₂SiO₅, and M₄Si₂O₈ (M is at least one element that is selected from a group consisting of Sr, Ba, Ca, Mg, Be, Zn, and Y) can be used as the silicate phosphor having another composition ratio. In order to control the emission color, part of Si may be substituted for germanium (Ge) (for example, (Sr_{(1-x-y-z)}BaₓCa_{y}Eu_{z})₂(Si₂₍₁₋ᵤ₎Geᵤ)O₄). At least one element that is selected from a group consisting of Ti, Pb, Mn, As, Al, Pr, Tb, and Ce may be contained as the activation agent.

(2) Aluminate phosphor: M₂Al₁₀O₁₇ (where M is at least one element that is selected from a group consisting of Ba, Sr, Mg, Zn, and Ca)

At least one element of Eu and Mn is contained as the activation agent. For example, MAl₂O₄, MAl₄O₁₇, MAl₈O₁₃, MAl₁₂O₁₉, M₂Al₁₉O₁₇, M₂Al₁₁O₁₉, M₃Al₅O₁₂, M₃Al₁₆O₂₇, and M₄Al₅O₁₂ (M is at least one element that is selected from a group consisting of Ba, Sr, Ca, Mg, Be, and Zn) can be used as the aluminate phosphor having another composition ratio. At least one element that is selected from a group consisting of Mn, Dy, Tb, Nd, and Ce may be contained as the activation agent.

(3) Nitride phosphor (mainly silicon nitride phosphor): LₓSi_{y}N_{(2x/3+4y/3)}:Eu or LₓSi_{y}O_{z}N_{(2x/3+/4y/3-2z/3)}:Eu (L is at least one element that is selected from a group consisting of Sr, Ca, Sr, and Ca)

Although the compositions of x=2 and y=5 or x=1 and y=7 are desirable, x and y can be set to arbitrary values. Desirably phosphors such as (SrₓCa₍₁₋ₓ₎)₂Si₅N₈:Eu, Sr₂Si₅N₈:Eu, Ca₂Si₅N₈:Eu, SrₓCa₍₁₋ₓ₎Si₇N₁₀:Eu, SrSi₇N₁₀:Eu, and CaSi₇N₁₀:Eu in which Mn is added as the activation agent are used as the nitride phosphor expressed by the chemical formulas. The phosphors may contain at least one element that is selected from a group consisting of Mg, Sr, Ca, Ba, Zn, B, Al, Cu, Mn, Cr, and Ni. At least one element that is selected from a group consisting of Ce, Pr, Tb, Nd, and La may be contained as the activation agent.

(4) Sulfide phosphor: (Zn₍₁₋ₓ₎Cdₓ)S:M (M is at least one element that is selected from a group consisting of Cu, Cl, Ag, Al, Fe, Cu, Ni, and Zn, and x is a numerical value satisfying 0≦x≦1)

S may be substituted for at least one of Se and Te.

(5) Oxysulfide phosphor: (Ln₍₁₋ₓ₎Euₓ)O₂S (Ln is at least one element that is selected from a group consisting of Sc, Y, La, Gd, and Lu, and x is a numerical value satisfying 0≦x≦1)

At least one element that is selected from a group consisting of Tb, Pr, Mg, Ti, Nb, Ta, Ga, Sm, and Tb may be contained as the activation agent.

(6) YAG phosphor: (Y_{(1-x-y-z)}GdₓLa_{y}Sm_{z})₃(Al₍₁₋ᵥ₎Gaᵥ)₅O₁₂:Ce,Eu (0≦x≦1, 0≦y≦1, 0≦z≦1, 0≦v≦1)

At least one of Cr and Tb may be contained as the activation agent.

(7) Borate phosphor: MBO₃:Eu (M is at least one element that is selected from a group consisting of Y, La, Gd, Lu, and In)

Tb may be contained as the activation agent. For example, Cd₂B₂O5₅:Mn, (Ce,Gd,Tb)MgB₅O₁₀:Mn, and GdMgB₅O₁₀:Ce,Tb can be used as the borate phosphor having another composition ratio.

(8) Phosphate-borate phosphor: 2(M₍₁₋ₓ₎M′ₓ)O.aP₂O₅.bB₂O₃ (M is at least one element that is selected from a group consisting of Mg, Ca, Sr, Ba, and Zn, M′ is at least one element that is selected from a group consisting of Eu, Mn, Sn, Fe, and Cr, and x, a, and b are numerical values satisfying 0.001≦x≦0.5, 0≦a≦2, 0≦b≦3, and 0.3<(a+b))

(9) Phosphate phosphor: (Sr₍₁₋ₓ₎Baₓ)₃(PO₄)₂:Eu or (Sr₍₁₋ₓ₎Baₓ)₂P₂O₇:Eu,Sn

At least one of Ti and Cu may be contained as the activation agent.

(10) Halophosphate phosphor: (M₍₁₋ₓ₎Euₓ)₁₀(PO₄)₆Cl₂ or (M₍₁₋ₓ₎Euₓ)₅(PO₄)₃Cl (M is at least one element that is selected from a group consisting of Ba, Sr, Ca, Mg, and Cd, and x is a numerical value satisfying 0≦x≦1)

At least part of Cl may be substituted for fluorine (F). At least one of Sb and Mn may be contained as the activation agent.

The phosphor can be used as a blue phosphor (or luminous body), a yellow phosphor (or luminous body), a green phosphor (or luminous body, a red phosphor (or luminous body), and a white phosphor (or luminous body) by appropriately selecting the phosphor. The phosphor (or luminous body) that emits light having an intermediate color can be formed by combining plural kinds of phosphors. The white phosphor (or luminous body) may be formed by combining phosphors having colors corresponding to red, green, and blue (RGB) that are three primary colors of the light, or by combining colors having a complementary color relationship like blue and yellow.

For the combinations of the phosphor particles, similarly to the embodiments, the phosphor layer in which plural kinds of the phosphor particles are mixed may be used, or the plural kinds of the phosphor particles may be formed into a laminar structure in which the phosphor particles are stacked layer by layer. For example, the phosphor particle layers having the colors corresponding to the RGB color are stacked as the layers corresponding to the RGB colors in the phosphor layer. At this point, the layer that emits the light having the shorter wavelength is disposed close to the semiconductor laser diode, thereby obtaining the light emitting device that efficiently emits the white light. The light emitting device in which the phosphor layer emits the white light is obtained even if the RGB phosphor particles are mixed in the transparent base material.

What is claimed is:

1. A light emitting device comprising:
a semiconductor laser diode emitting a laser beam;
first and second sidewalls being disposed along a central beam axis of the laser beam with opposite each other;
a phosphor layer being provided between the first and second sidewalls, the phosphor layer having an incidence surface of the laser beam, the incidence surface being inclined with respect to the central beam axis, the phosphor layer absorbing the laser beam to emit visible light on the incidence surface side;
a slit being provided above the incidence surface to take out the visible light, the slit having a longitudinal direction and a crosswise direction, the longitudinal direction being disposed along a direction of the central beam axis; and
a reflector being provided in a region between the semiconductor laser diode and the slit so as not to intersect the central beam axis, the reflector reflecting part of the laser beam toward the phosphor layer.

2. The device according to claim 1, wherein an inclination angle between the incidence surface and the central beam axis is not kept constant, and the incidence surface has a region, the region has the inclination angle larger than that at a position at which the incidence surface intersects the central beam axis, the region being provided at a position that is farther from the semiconductor laser diode than the position at which the incidence surface intersects the central beam axis.

3. The device according to claim 1, wherein an inclination angle between the incidence surface and the central beam axis is not kept constant, and the incidence surface has a region, the region has the inclination angle larger than that at a position at which the incidence surface intersects the central beam axis, the region being provided at a position that is closer to the semiconductor laser diode than the position at which the incidence surface intersects the central beam axis.

4. The device according to claim 2, wherein the incidence surface is a continuous curved surface.

5. The device according to claim 3, wherein the incidence surface is a continuous curved surface.

6. The device according to claim 2, wherein the inclination angle is minimized at a position at which the incidence surface intersects the central beam axis.

7. The device according to claim 3, wherein the inclination angle is minimized at a position at which the incidence surface intersects the central beam axis.

8. A light emitting device comprising:
a semiconductor laser diode emitting a laser beam;
first and second sidewalls being disposed along a central beam axis of the laser beam with opposite each other;
a phosphor layer being provided between the first and second sidewalls, the phosphor layer having an inclined surface being inclined with respect to the central beam axis;
a slit being provided above the inclined surface, the slit having a longitudinal direction and a crosswise direction, the longitudinal direction being disposed along a direction of the central beam axis; and
a reflector being provided between the semiconductor laser diode and the slit and above the inclined surface so as not to intersect the central beam axis.

9. The device according to claim 8, wherein an inclination angle between the inclined surface and the central beam axis is not kept constant, and the inclined surface has a region, the region has the inclination angle larger than that at a position at which the inclined surface intersects the central beam axis, the region being provided at a position that is farther from the semiconductor laser diode than the position at which the inclined surface intersects the central beam axis.

10. The device according to claim 8, wherein an inclination angle between the inclined surface and the central beam axis is not kept constant, and the inclined surface has a region, the region has the inclination angle larger than that at a position at which the inclined surface intersects the central beam axis, at a position that is closer to the semiconductor laser diode than the position at which the inclined surface intersects the central beam axis.

11. The device according to claim 9, wherein the inclined surface is a continuous curved surface.

12. The device according to claim 10, wherein the inclined surface is a continuous curved surface.

13. The device according to claim 9, wherein the inclination angle is minimized at a position at which the inclined surface intersects the central beam axis.

14. The device according to claim 10, wherein the inclination angle is minimized at a position at which the inclined surface intersects the central beam axis.
